(19) United States
(12) Patent Application Publication
(10) Pub. No.: US 2026/0284868 A1
(43) Pub. Date: Sep. 24, 2026

(54) MOBILE ROBOT LEG ACTUATOR TORQUE BALANCING AND RELATED TECHNOLOGY

(71) Applicant: Agility Robotics, Inc., Pittsburgh, PA (US)

(72) Inventors: Andrew Abate, Corvallis, OR (US); Jay Jasper, Corvallis, OR (US); Jonathan Hurst, Albany, OR (US)

(21) Appl. No.: 19/292,410

(22) Filed: Aug. 6, 2025

Related U.S. Application Data
(60) Provisional application No. 63/775,886, filed on Mar. 21, 2025.
(60) Provisional application No. 63/825,464, filed on Jun. 17, 2025.

(51) Int. Cl. B25J 9/10; B25J 9/00; B62D 57/032

(52) U.S. Cl. CPC B25J 9/106; B25J 9/0072; B62D 57/032

(57) ABSTRACT

A method in accordance with a particular embodiment of the present technology involves a mobile robot including a leg having a first link and a second link distal to the first link. During the method, the mobile robot defines a first plane that is vertical and parallel to a length of the first link. The mobile robot also defines a second plane that intersects centers of pressure and gravity of the mobile robot and is perpendicular to the first plane. The method includes operating the mobile robot in a standing state while the length of the first link is less than 30 degrees off vertical and operating the mobile robot in a non-standing state while the length of the first link is less than 30 degrees off horizontal and while the second plane intersects a middle 25% of the length of the first link.

### CROSS-REFERENCE TO RELATED APPLICATION

This claims the benefit of U.S. Provisional Application No. 63/775,886, filed Mar. 21, 2025 and U.S. Provisional Application No. 63/825,464, filed Jun. 17, 2025. The foregoing applications are incorporated herein by reference in their entirety. To the extent the foregoing applications or any other material incorporated by reference conflicts with the present disclosure, the present disclosure controls.

### TECHNICAL FIELD

The present technology relates to mobile robots.

### BACKGROUND

Much of the work that humans currently perform is amenable to automation using robotics. For example, many human workers currently focus on executing predefined movements of items and containers at order-fulfillment centers. Such predefined movements may occur millions of times a day at a single order-fulfillment center and billions of times a day across a network of order-fulfillment centers. Human effort is better suited to more complex tasks, particularly those involving creativity, advanced problem solving, and social interaction. Presently, however, the need for order-fulfillment centers is large and rapidly increasing. Some analysts forecast a shortage of a million or more workers to staff order-fulfillment centers within the next ten to fifteen years. Due to the importance of this field, even small improvements in efficiency can have major impacts on macroeconomic productivity. For at least these reasons, there is a significant and growing need for innovation that supports automating tasks that humans currently perform at order-fulfillment centers and elsewhere.

### BRIEF DESCRIPTION OF THE DRAWINGS

Certain aspects of the present technology can be better understood with reference to the following drawings. The relative dimensions in the drawings may be to scale with respect to some embodiments of the present technology. With respect to other embodiments, the drawings may not be to scale. The drawings may also be enlarged arbitrarily. For clarity, reference-number labels for analogous features may be omitted when the appropriate reference-number labels for such analogous features are clear in the context of the specification and all of the drawings considered together. Furthermore, the same reference numbers may be used to identify analogous features in multiple described embodiments.

FIG. 1 is a perspective view of a mobile robot relevant to methods in accordance with at least some embodiments of the present technology.

FIGS. 2, 3 and 4 are a front profile view, a side profile view, and a kinematic representation, respectively, of a leg of the mobile robot of FIG. 1.

FIGS. 5, 6 and 7 are a front profile view, a side profile view, and a kinematic representation, respectively, of another leg of the mobile robot of FIG. 1.

FIGS. 8 and 9 are a front profile view and a side profile view, respectively, of the mobile robot of FIG. 1.

FIG. 10 is a block diagram corresponding to a method in accordance with at least some embodiments of the present technology.

FIGS. 11-13 are profile views of the mobile robot of FIG. 1 at different respective times during an example of a method in accordance with at least some embodiments of the present technology.

FIG. 14 is a block diagram corresponding to another method in accordance with at least some embodiments of the present technology.

FIGS. 15-17 are profile views of the mobile robot of FIG. 1 at different respective times during an example of another method in accordance with at least some embodiments of the present technology.

FIG. 18 is a block diagram depicting a system including electrical, computer, and software components operably associated with a mobile robot relevant to methods in accordance with at least some embodiments of the present technology.

FIG. 19 is a block diagram depicting software architecture and associated portions of the system of FIG. 18.

### DETAILED DESCRIPTION

Disclosed herein are methods, devices, and systems related to mobile robots. An example of a mobile robot relevant to at least some embodiments of the present technology includes a body and a leg that carries at least a portion of a weight of the body during locomotion. The leg includes links and joints interposed along a kinematic chain. Among the links, the leg includes a thigh link at a location along the kinematic chain the same as or similar to the location of a human thigh along a kinematic chain corresponding to a human leg. Among the joints, the mobile robot includes knee and hip joints at distal and proximal end portions, respectively, of the thigh link. The mobile robot further includes knee and hip actuators operably associated with the knee and hip joints, respectively. By controlling operation of the knee and hip actuators (and/or other suitable actuators), the mobile robot can implement various behaviors involving the leg (e.g., gaits) and maintain dynamic stability. Methods, devices, and systems in accordance with at least some embodiments of the present technology involve aspects of this leg control in the context of crouching behaviors.

For cost, efficiency, durability, and/or other reasons, it tends to be useful for a maximum operating load on any given leg actuator of a mobile robot to be as small as possible. Crouching behaviors, however, have the potential to cause very high loads on knee and hip actuators. In the example discussed above, the load on the knee actuator at any given time may correspond directly to a horizontal distance between the knee joint and a coronal plane of the mobile robot that extends through both a center of pressure of the mobile robot and a center of gravity of the mobile robot. Crouching may move the thigh link toward horizontal, thereby increasing a total horizontal distance between the knee and hip joints and, therefore, the loads on the knee and hip actuators. Methods in accordance with at least some embodiments of the present technology include causing the mobile robot to move preferentially during a crouching behavior through and into poses that promote balancing of loads on these actuators. This can reduce the necessary sizes of the knee and hip actuators, reduce the necessary weights of the knee and hip actuators, and/or increase the energy efficiency of the mobile robot 100 during crouching.

The energy advantages of promoting balanced loads on the knee and hip actuators may be especially pronounced when a crouching behavior by the mobile robot is sustained rather than transient. Conventionally, sustained crouching by a legged mobile robot is unknown or unusual. Conventional legged mobile robots implement most, if not all behaviors while standing. Sustained crouching, however, is expected to be relatively frequent in practice for mobile robots in accordance with at least some embodiments of the present technology. As an example, a method in accordance with at least some embodiments of the present technology includes causing a mobile robot to crouch in response to hazard information about a human in an environment in which the mobile robot operates. Among other things, this crouching may reduce the risk of a collision between the mobile robot and the human. This risk may be present for a relatively long period of time. During this time, the mobile robot may sustain a crouching configuration while stationary, while ambulating, and/or while implementing another productive behavior (e.g., while manipulating an object). In these and other cases, control features in accordance with at least some embodiment of the present technology may increase the practicality and/or feasibility of sustained crouching.

Typically, a mobile robot implements a behavior through one or more solvers. For example, a solver may determine intermediate poses that the mobile robot should move through during implementation of the behavior, joint angles corresponding to the intermediate poses, and actuator commands corresponding to the joint angles. The geometry of the mobile robot constrains the corresponding calculations with respect to a given intermediate pose. The same overall behavior, however, may be achievable via many different intermediate poses and combinations thereof. Crouching, for example, may involve a variety of different intermediate poses. When multiple valid intermediate poses satisfy a behavior, a solver working to implement the behavior may use other factors to select among these intermediate poses. These factors may include secondary objectives, such as reducing singularities and promoting smooth motions, among others. Methods in accordance with at least some embodiments of the present technology include use of one or more factors that promote even distribution of loads on knee and hip actuators during crouching. In this or another suitable manner, methods, devices, and systems in accordance with at least some embodiments of the present technology provide meaningful advantages over conventional technologies.

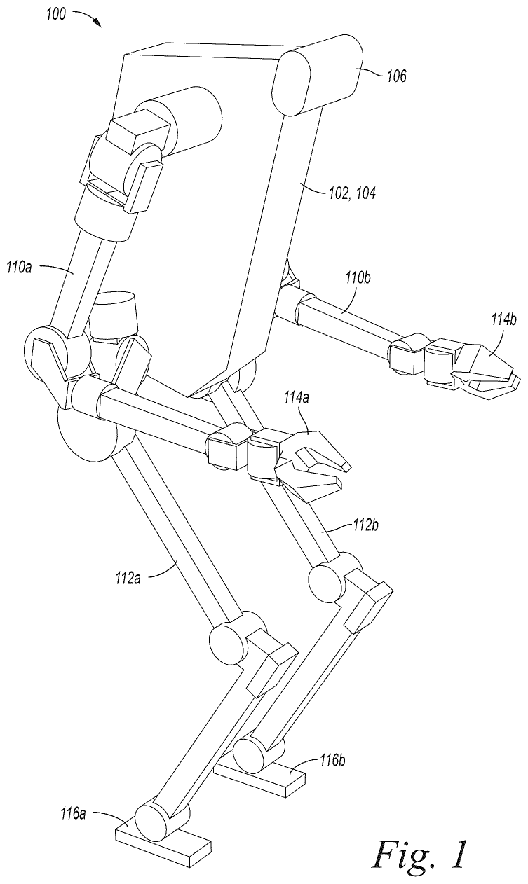

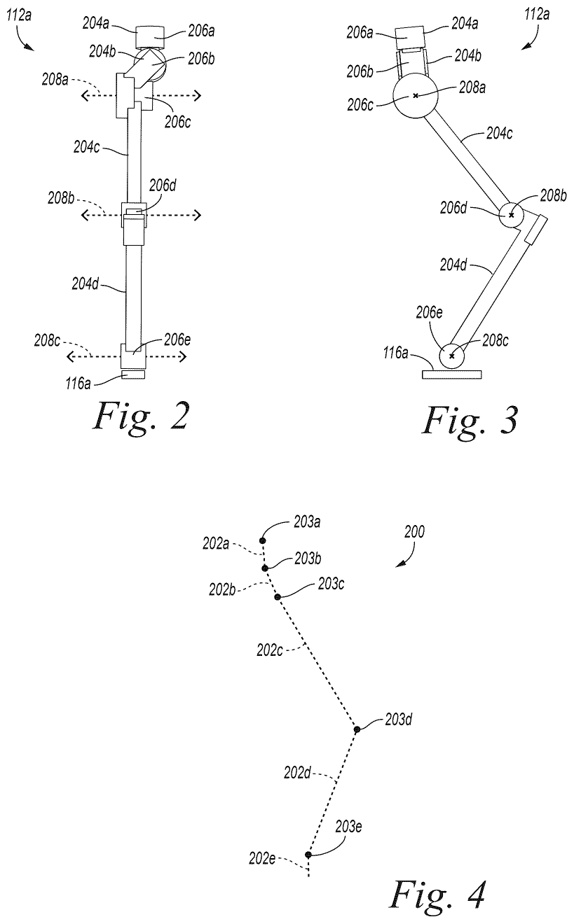

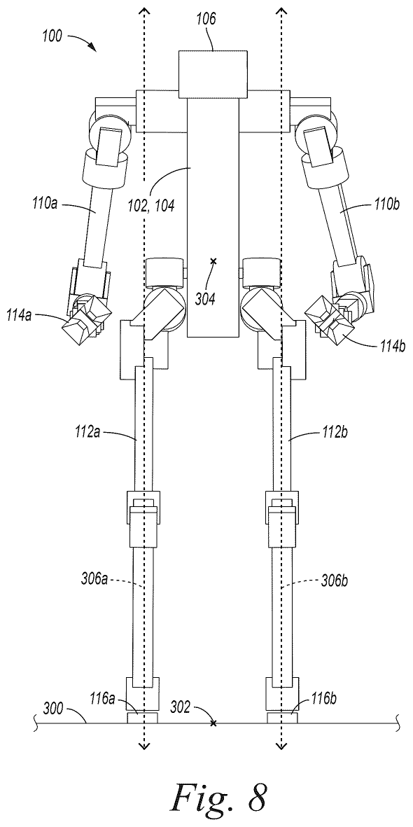

The foregoing and many other features of methods, devices, and systems in accordance with various embodiments of the present technology are further described below with reference to FIGS. 1-19. Although methods, devices, and systems may be described herein primarily or entirely in the context of bimanual, bipedal robots, other contexts are within the scope of the present technology. For example, suitable features of described methods, devices, and systems can be implemented in the context of mobile robots with one arm, in the context of mobile robots with more than two arms, and/or in the context of non-legged mobile robots. Furthermore, it should be understood, in general, that other methods, devices, and systems in addition to those disclosed herein are within the scope of the present technology. For example, methods, devices, and systems in accordance with embodiments of the present technology can have different and/or additional configurations, components, procedures, etc. than those disclosed herein. Moreover, methods, devices, and systems in accordance with embodiments of the present technology can be without one or more of the configurations, components, procedures, etc. disclosed herein without deviating from the present technology.

### Examples of Mobile Robots

FIG. 1 is a perspective view of a mobile robot 100 relevant to methods in accordance with at least some embodiments of the present technology. As shown in FIG. 1, the mobile robot 100 can be humanoid in form. It can include structures resembling human anatomy with respect to the features, positions, and/or other characteristics of such structures. In at least some cases, the mobile robot 100 defines a midsagittal plane (not shown) about which it is bilaterally symmetrical. In these and other cases, the mobile robot 100 can be configured for locomotion similar to that of a human. Counterparts of the mobile robot 100 can have other suitable features. For example, a counterpart of the mobile robot 100 can have a non-humanoid form, such as a canine form, an insectoid form, an arachnoid form, or a form with no animal analog. Furthermore, a counterpart of the mobile robot 100 can be asymmetrical or have symmetry other than bilateral. Still further, a counterpart of the mobile robot 100 can be configured for non-bipedal locomotion. For example, a counterpart of the mobile robot 100 can be configured for another type of legged locomotion (e.g., quadrupedal locomotion, hexapedal locomotion, octopedal locomotion, etc.) or non-legged locomotion (e.g., wheeled locomotion, continuous-track locomotion, etc.).

With reference again to FIG. 1, the mobile robot 100 can include a centrally disposed body 102 through which other structures are interconnected. As all or a portion of the body 102, the mobile robot 100 can include a torso 104. The mobile robot 100 can further include a head 106 at a superior portion of the torso 104. The mobile robot 100 can also include articulated appendages carried by the torso 104. Among these articulated appendages, the mobile robot 100 can include arms 110 (individually identified as arms 110a, 110b) and legs 112 (individually identified as legs 112a, 112b) extending distally from the body 102. At individual articulations of the arms 110a, 110b and legs 112a, 112b, the mobile robot 100 can include a joint and a corresponding actuator, such as an electromechanical, rotary actuator with a motor and gearing (e.g., cycloidal, strain-wave, or planetary gearing). Rather than being positioned at a joint, some actuators of the mobile robot 100 may be operably associated with a joint via a connecting structure, such as a connecting rod or cable.

The mobile robot 100 can be configured to manipulate objects via the arms 110a, 110b, such as bimanually. The mobile robot 100 can be configured to ambulate via the legs 112a, 112b, such as bipedally. The arms 110a, 110b and the legs 112a, 112b can separately extend from the body 102 and define respective kinematic chains. The individual kinematic chains corresponding to the arms 110a, 110b can provide at least five degrees of freedom, such as exactly five or exactly six degrees of freedom. In these and other cases, the respective kinematic chains corresponding to the legs 112a, 112b can provide at least four degrees of freedom, such as exactly four, exactly five, or exactly six degrees of freedom. As parts of the arms 110a, 110b and at distalmost portions of the corresponding kinematic chains, the mobile robot 100 can include end effectors 114a, 114b. Similarly, as parts of the legs 112a, 112b and at distalmost portions of the corresponding kinematic chains, the mobile robot 100 can include feet 116a, 116b. Thus, the arms 110a, 110b and the legs 112a, 112b can distally carry the end effectors 114a, 114b and the feet 116a, 116b, respectively.

FIGS. 2, 3 and 4 are a front profile view, a side profile view, and a kinematic representation, respectively, of the leg 112a. With reference to FIGS. 1-4 together, the leg 112a can define a kinematic chain 200 including segments 202 (individually identified as segments 202a-202e) and nodes 203 (individually identified as nodes 203a-203e) proximal to and between the segments 202a-202e. The leg 112a can include links 204 (individually identified as links 204a-204d) at the segments 202a-202d, respectively, and at successively more distal portions of the kinematic chain 200. Similarly, the leg 112a can include joints 206 (individually identified as joints 206a-206e) at the nodes 203a-203e, respectively, and at successively more distal portions of the kinematic chain 200. The joints 206c-206e can be rotatable about axes 208a-208c, respectively. The foot 116a can be at a distal end portion of the kinematic chain 200. The leg 112a can further define a total length (not labeled) coextensive with the kinematic chain 200 and extending from the joint 206a (as a proximalmost joint of the leg 112a) to a distalmost portion of the foot 116a. In at least some cases, the links 204c, 204d are elongate. The links 204c, 204d can define respective lengths coextensive with the segments 202c, 202d, respectively. Correspondingly, the length of the link 204c can intersect the axes 208a, 208b at the joints 206c, 206d, respectively. Similarly, the length of the link 204d can intersect the axes 208b, 208c at the joints 206d, 206e, respectively.

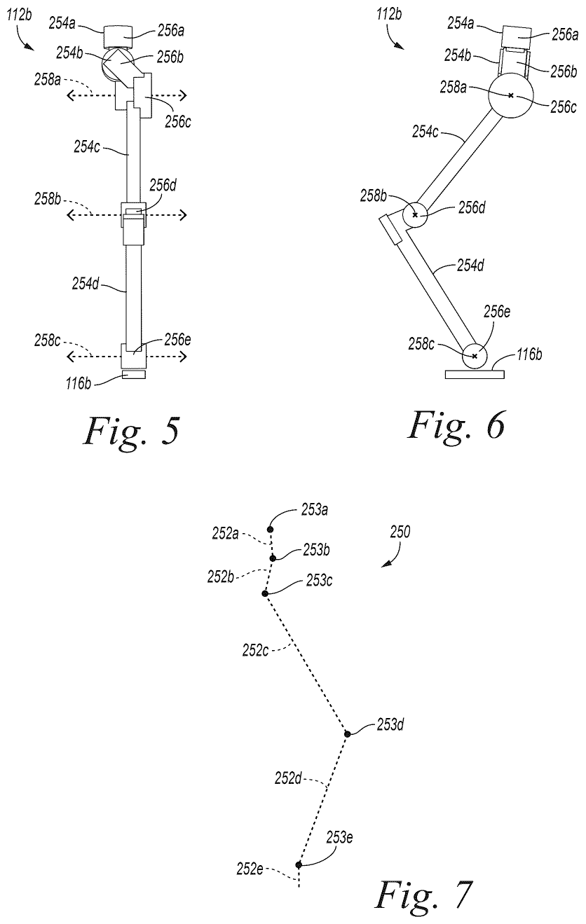

FIGS. 5, 6 and 7 are a front profile view, a side profile view, and a kinematic representation, respectively, of the leg 112b. With reference to FIGS. 1 and 5-7 together, the leg 112b can define a kinematic chain 250 including segments 252 (individually identified as segments 252a-252e) and nodes 253 (individually identified as nodes 253a-253e) proximal to and between the segments 252a-252e. The leg 112b can include links 254 (individually identified as links 254a-254d) at the segments 252a-252d, respectively, and at successively more distal portions of the kinematic chain 250. Similarly, the leg 112b can include joints 256 (individually identified as joints 256a-256e) at the nodes 253a-253e, respectively, and at successively more distal portions of the kinematic chain 250. The joints 256c-256e can be rotatable about axes 258a-258c, respectively. The foot 116b can be at a distal end portion of the kinematic chain 250. The leg 112b can further define a total length (not labeled) coextensive with the kinematic chain 250 and extending from the joint 256a (as a proximalmost joint of the leg 112b) to a distalmost portion of the foot 116b. In at least some cases, the links 254c, 254d are elongate. The links 254c, 254d can define respective lengths coextensive with the segments 252c, 252d, respectively. Correspondingly, the length of the link 254c can intersect the axes 258a, 258b at the joints 256c, 256d, respectively. Similarly, the length of the link 254d can intersect the axes 258b, 258c at the joints 256d, 256e, respectively.

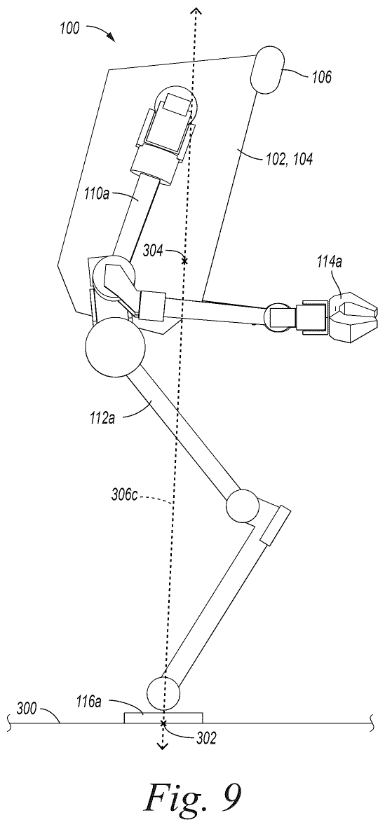

FIGS. 8 and 9 are a front profile view and a side profile view, respectively, of the mobile robot 100. In FIGS. 8 and 9, the mobile robot 100 is shown with the feet 116a, 116b planted on a ground surface 300. With reference to FIGS. 1-9 together, the mobile robot 100 can define a center of pressure 302 on the ground surface 300. The mobile robot 100 can also define a center of gravity 304. In the illustrated example, the mobile robot 100 is not carrying a payload. Accordingly, the center of gravity 304 may correspond to a mass distribution of integral components (e.g., integral links, actuators, etc.) and any attachments (e.g., swappable end effectors) of the mobile robot 100 itself. When the mobile robot 100 is carrying a payload, the center of gravity 304 can correspond to a mass distribution of these portions of the mobile robot 100 and the payload collectively. Accordingly, the center of gravity 304 shifts as the mobile robot 100 retrieves a payload, places a payload, and/or otherwise moves a payload relative to the integral components and/or attachments of the mobile robot 100.

In at least some cases, the links 204c, 254c correspond to right and left thighs (or upper leg regions), respectively, of a human. Similarly, the links 204d, 254d can correspond to right and left shins (or lower leg regions), respectively, of a human. Also similarly, the joints 206c, 256c can correspond to right and left hip joints, respectively, of a human. Also similarly, the joints 206d, 256d can correspond to right and left knee joints, respectively, of a human. In these and other cases, the joint 206d can be at a middle 35% (e.g., a middle 25%) of the total length of the leg 112a. Similarly, the joint 256d can be at a middle 35% (e.g., a middle 25%) of the total length of the leg 112b.

The mobile robot 100 can define planes 306a-306c during operation. The plane 306a (FIG. 8) can be vertical, parallel to the length of the link 204c, and parallel to the segment 202c. The plane 306b (FIG. 8) can be vertical, parallel to the length of the link 254c, and parallel to the segment 252c. The plane 306c (FIG. 9) can intersect the center of pressure 302, intersect the center of gravity 304, and be perpendicular to the planes 306a, 306b. The plane 306c can correspond to a line of action at a given time. When the mobile robot 100 is statically balanced, the line of action is vertical (opposing gravity) and within the support polygon. Dynamic moves cause the line of action to deviate from vertical and from intersecting the center of gravity 304. The mobile robot 100 can change its configuration to compensate for these moves and to urge the line of action toward vertical.

In the illustrated case, the planes 306a, 306b are parallel to one another. In other cases, the planes 306a, 306b can be non-parallel to one another. In these cases, the mobile robot 100 can define two counterpart planes (not shown) corresponding to the plane 306c. The first of these counterpart planes can intersect the center of pressure 302, intersect the center of gravity 304, and be perpendicular to the plane 306a. The second of these counterpart planes can intersect the center of pressure 302, intersect the center of gravity 304, and be perpendicular to the plane 306b. Furthermore, the relative positions of the center of pressure 302, the center of gravity 304, the planes 306a-306c, and the counterparts of the plane 306c can change as the mobile robot 100 moves. Thus, the planes 306a, 306b can be parallel to one another at some times and non-parallel to one another at other times. As with the links 204a-204d, the planes 306a-306c can be anatomical. For example, the planes 306a, 306b can be sagittal planes offset from a midsagittal plane (not shown) of the mobile robot 100 in opposite respective lateral directions. Furthermore, the plane 306c and the counterparts of the plane 306c can be coronal planes of the mobile robot 100.

### Examples of Methods

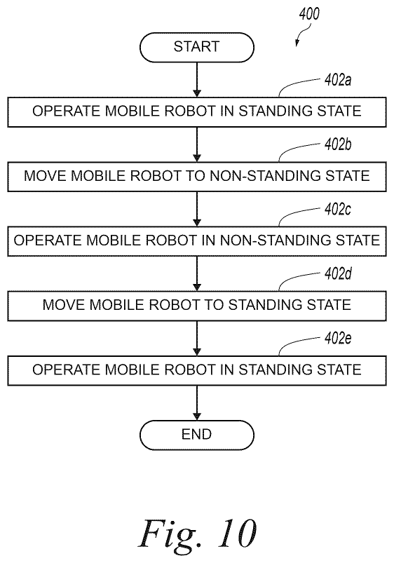

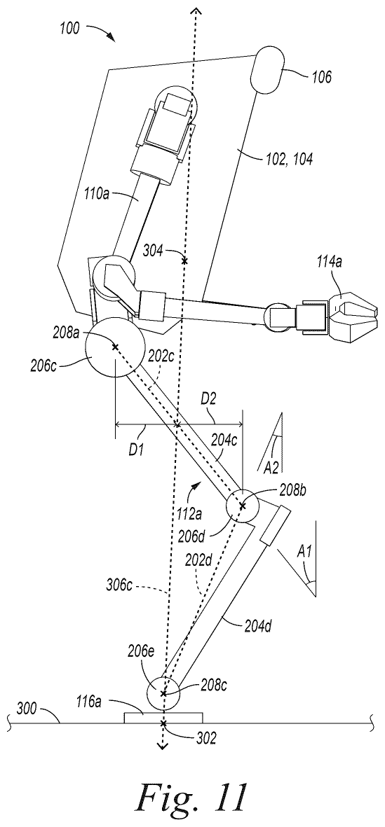

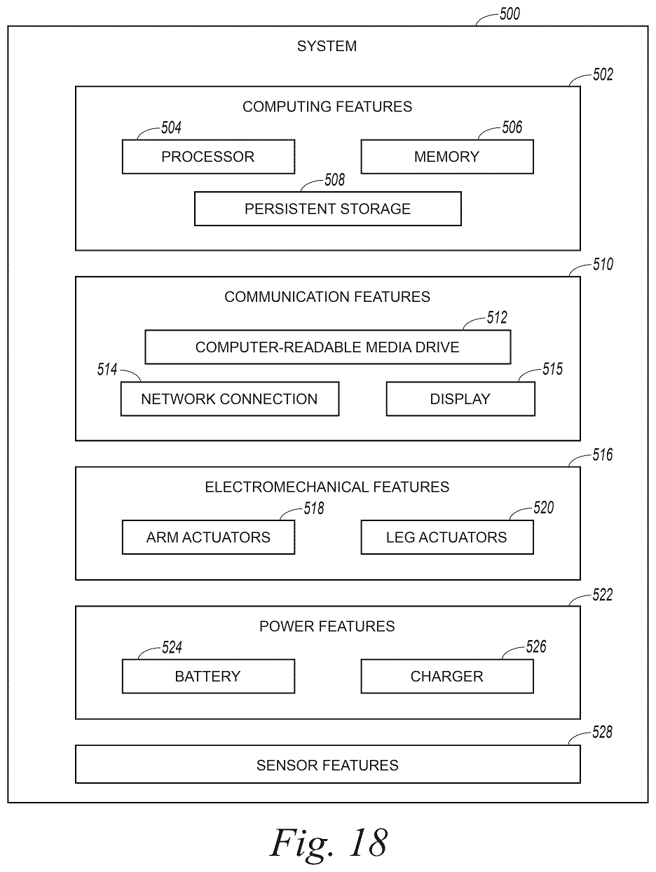

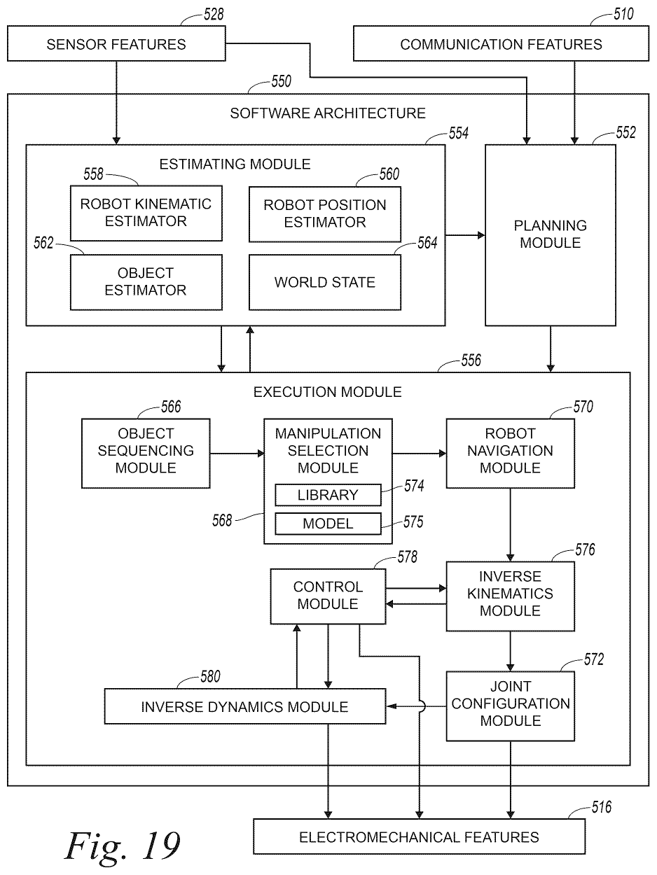

FIG. 10 is a block diagram corresponding to a method 400 in accordance with at least some embodiments of the present technology. The diagram includes blocks 402a-402e corresponding to different respective portions of the method 400. Features of the method 400 are described herein primarily in the context of the mobile robot 100. It should be understood, however, that various examples of the method 400 can be implemented in accordance with other mobile robots. Furthermore, suitable aspects of the method 400 can be implemented at least partially via a computer system (not shown) operably associated with the mobile robot 100. Where aspects of the method 400 are described herein as performed by the mobile robot 100, it should be understood that these descriptions include performing such aspects entirely or partially by the computer system. Further details regarding various examples of the computer system are provided below in the context of FIGS. 18 and 19. The mobile robot 100 can carry the computer system. Alternatively, all or a portion of the computer system can be remote and operably associated with the mobile robot 100 via suitable communication hardware.

FIGS. 11-13 are profile views of the mobile robot 100 at different respective times during an example of the method 400. With reference to FIGS. 1-13 together, the method 400 can include operating the mobile robot 100 in a standing state (block 402a). FIG. 11 corresponds to this time during the method 400. As shown in FIG. 11, the segment 202c and the length of the link 204c can be at an angle A1 off vertical. In at least some cases, the angle A1 is less than 45 degrees (e.g., less than 30 degrees) while the mobile robot 100 operates in the standing state. In these and other cases, the segment 252c and the length of the link 254c can likewise be off vertical by less than 45 degrees (e.g., less than 30 degrees) while the mobile robot 100 operates in the standing state. As also shown in FIG. 11, the segment 202d and the length of the link 204d can be at an angle A2 off vertical. In at least some cases, the angle A2 is less than 45 degrees (e.g., less than 30 degrees) while the mobile robot 100 operates in the standing state. In these and other cases, the segment 252d the length of the link 254d can likewise be off vertical by less than 45 degrees (e.g., less than 30 degrees) while the mobile robot 100 operates in the standing state.

With continued reference to FIG. 11, the plane 306c can intersect a middle 25% (e.g., a middle 15%) of the segment 202c and of the length of the link 204c while the mobile robot 100 operates in the standing state. Similarly, the plane 306c can intersect a middle 25% (e.g., a middle 15%) of the segment 252c length of the link 254c while the mobile robot 100 operates in the standing state. When the respective lengths of the links 204c, 254c are not parallel to one another, the counterparts of the plane 306c (as described above) can intersect the middle 25% (e.g., the middle 15%) of the respective segments 202c, 252c and of the respective lengths of the corresponding links 204c, 254c while the mobile robot 100 operates in the standing state. As further shown in FIG. 11, a horizontal distance D1 between the joint 206c and an intersection between the plane 306c and the length of the link 204c can be the same as or similar to (e.g., within 25% of, within 15% of, etc.) a horizontal distance D2 between the joint 206d and this intersection while the mobile robot 100 operates in the standing state. Similarly, horizontal distances (not shown) between the joints 256c, 256d and an intersection between the plane 306c and the length of the link 254c can be the same as or similar to (e.g., within 25% of, within 15% of, etc.) one another while the mobile robot 100 operates in the standing state. Again, when the respective lengths of the links 204c, 254c are not parallel to one another, the same or similar relationships can apply between the counterparts of the plane 306c and the joints of the corresponding legs 112a, 112b while the mobile robot 100 operates in the standing state.

The forgoing and/or other features of the pose of the mobile robot 100 in the standing state can promote even balancing of loads on actuators operably associated with the joints 206c, 206d, respectively, and/or even balancing of loads on actuators operably associated with the joints 256c, 256d, respectively. It should be noted that although D1 and D2 need are horizontal because the plane 306c is vertical when the mobile robot 100 is statically stable. In a dynamic state, a more accurate representation of the balance of torque between the knee and hip actuators is a line perpendicular to the line of action. Thus, D1 and D2 are simplified variables corresponding to the balance of torque without necessarily representing the exact balance of torque at a given instant during dynamic balancing of the mobile robot 100.

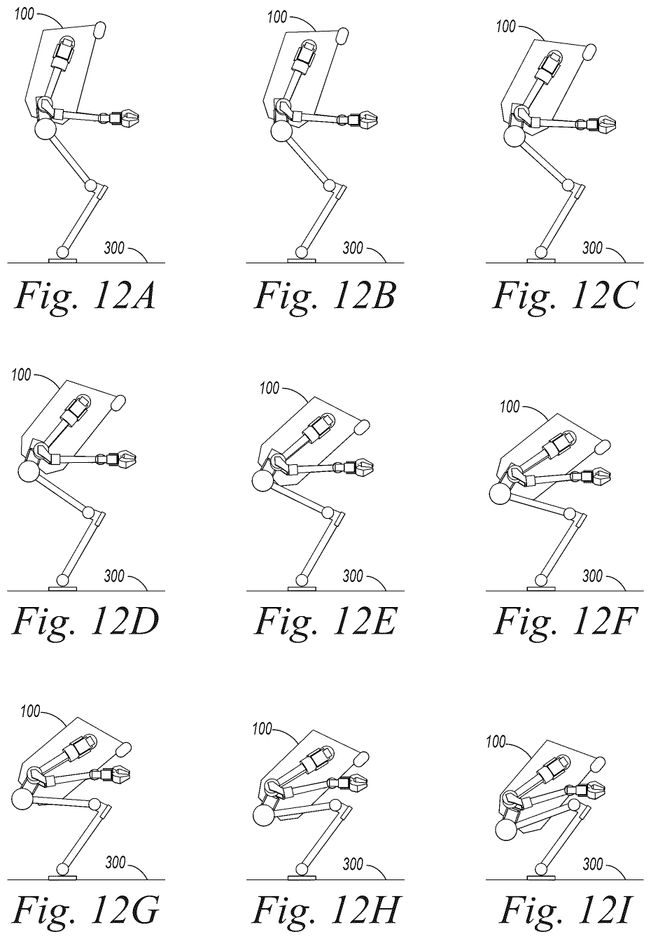

The method 400 can further include moving the mobile robot 100 from the standing state to a non-standing state (block 402b). In at least some cases, the non-standing state is a crouching state. FIGS. 12A-12I correspond to this time during the method 400. As shown in FIGS. 12A-12I, reconfiguration of the mobile robot 100 toward the non-standing state can include bending the joints 206c, 206d, 256c, 256d to lower an inferior portion of the body 102 (and of the torso 104) toward the ground surface 300 and to tilt a superior portion of the body 102 (and of the torso 104) anteriorly. Portions of the legs 112a, 112b distal to the joints 206d, 256d can remain relatively stationary. In at least some cases, moving the mobile robot 100 from the standing state to the non-standing state includes tilting the superior portion of body 102 (and of the torso 104) anteriorly at least 10 degrees (e.g., at least 15 degrees) relative to the legs 112a, 112b.

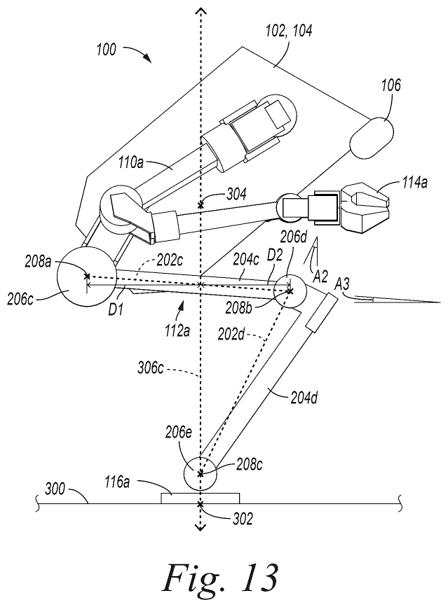

The method 400 can further include operating the mobile robot 100 in the non-standing state (block 402c). FIG. 13 corresponds to this time during the method 400. As shown in FIG. 13, significant changes in the pose of the mobile robot 100 from the standing state to the non-standing state can include movement of the links 204c, 254c toward horizontal and anterior tilting of the superior portion of body 102 (and of the torso 104). The segment 202c and the length of the link 204c can be at an angle A3 (FIG. 13) off horizontal. In at least some cases, the angle A3 is less than 30 degrees (e.g., less than 15 degrees) while the mobile robot 100 operates in the non-standing state. In these and other cases, the segment 252c and the length of the link 254c can likewise be off horizontal by less than 30 degrees (e.g., less than 15 degrees) while the mobile robot 100 operates in the non-standing state. The angle A2 can be (e.g., remain) less than 45 degrees (e.g., less than 30 degrees) while the mobile robot 100 operates in the non-standing state. Similarly, the segment 252d and the length of the link 254d can be (e.g., remain) off vertical by less than 45 degrees (e.g., less than 30 degrees) while the mobile robot 100 operates in the non-standing state. In these and other cases, the angle A2 may change relatively little between the standing and non-standing states (e.g., by less than 15 degrees, by less than 10 degrees, etc.).

Features of the standing state discussed above for promoting even balancing of loads on actuators operably associated with the joints 206c, 206d, respectively, and/or even balancing of loads on actuators operably associated with the joints 256c, 256d, respectively, can apply while the mobile robot 100 moves to the non-standing state and/or while the mobile robot 100 operates in the non-standing state. The plane 306c can intersect the middle 25% (e.g., the middle 15%) of the segment 202c and the length of the link 204c while the mobile robot 100 moves to the non-standing state and/or while the mobile robot 100 operates in the non-standing state. Similarly, the plane 306c can intersect the middle 25% (e.g., the middle 15%) of the segment 252c and the length of the link 254c while the mobile robot 100 moves to the non-standing state and/or while the mobile robot 100 operates in the non-standing state. When the respective lengths of the links 204c, 254c are not parallel to one another, the counterparts of the plane 306c (as described above) can intersect the middle 25% (e.g., the middle 15%) of the respective lengths of the corresponding links 204c, 254c while the mobile robot 100 moves to the non-standing state and/or while the mobile robot 100 operates in the non-standing state. Relatedly, the horizontal distance D1 can be the same as or similar to (e.g., within 25% of, within 15% of, etc.) the horizontal distance D2 while the mobile robot 100 moves to the non-standing state and/or while the mobile robot 100 operates in the non-standing state. Similarly, horizontal distances (not shown) between the joints 256c, 256d and the intersection between the plane 306c and the length of the link 254c can be the same or similar to (e.g., within 25% of, within 15% of, etc.) one another while the mobile robot 100 moves to the non-standing state and/or while the mobile robot 100 operates in the non-standing state. Again, when the respective lengths of the links 204c, 254c are not parallel to one another, the same or similar horizontal distance relationships can apply between the counterparts of the plane 306c and the joints of the corresponding links legs 112a, 112b while the mobile robot 100 moves to the non-standing state and/or while the mobile robot 100 operates in the non-standing state.

In at least some cases, any or all of the features for promoting even balancing of loads on actuators operably associated with the joints 206c, 206d, respectively, and/or even balancing of loads on actuators operably associated with the joints 256c, 256d, respectively, persist over a continuous period of time during which the mobile robot 100 operates in the standing state, moves to the non-standing state, and then operates in the non-standing state. Similarly, any or all of these features can persist over a continuous period of time during which the mobile robot 100 operates in the non-standing state, moves to the standing state, and then operates in the standing state. In these and other cases, operating the mobile robot 100 in the non-standing state can be sustained rather than transient. For example, operating the mobile robot 100 in the non-standing state may continue for at least five consecutive seconds, at least 10 consecutive seconds, etc. As discussed above, operating the mobile robot 100 in the non-standing state may be related to a safety condition that does not resolve quickly. For efficiency and/or other reasons, it may be useful for the mobile robot 100 to continue working and/or moving while operating in the non-standing state. Accordingly, operating the mobile robot 100 in the non-standing state can include ambulating the mobile robot 100 (e.g., bipedally) in this state. This can include executing at least two complete and consecutive steps via the leg 112a and executing at least two complete and consecutive steps via the leg 112b. In addition or alternatively, the method 400 can include retrieving an object while the mobile robot 100 is in the non-standing state, such as bimanually via the arms 110a, 110b. Other productive actions by the mobile robot 100 in the non-standing state are also possible. Alternatively, operating the mobile robot 100 in the non-standing state may include simply maintaining the mobile robot 100 in a relatively stationary position. Moreover, these and other examples of operating the mobile robot 100 in the non-standing state can be for reasons other than or in addition to safety. For example, operating the mobile robot 100 in the non-standing state may be useful when the mobile robot 100 is deployed in or must move through an area with low vertical clearance.

The method 400 can further include moving the mobile robot 100 to the standing state (block 402d). In at least some cases, this includes reversing the reconfiguration described above. Moreover, any or all of the features for promoting even balancing of loads on actuators operably associated with the joints 206c, 206d, respectively, and/or even balancing of loads on actuators operably associated with the joints 256c, 256d, respectively, present while moving the mobile robot 100 to the non-standing state may likewise be present while moving the mobile robot 100 to the standing state. Finally, the method 400 can include operating the mobile robot 100 in the standing state (block 402e) after moving the mobile robot 100 to the standing state. This can include any of the features described above for operating the mobile robot 100 in the standing state before moving the mobile robot 100 to the non-standing state. Movement of the mobile robot 100 to the standing state after operating the mobile robot 100 in the non-standing state can be at least partially in response to lessening or a hazard, movement of the mobile robot 100 out of a low-vertical-clearance area, and/or for one or more other reasons.

The mobile robot 100 may be dynamically stable while operating in the standing state, while moving to the non-standing state, while operating in the non-standing state, and/or while moving to the standing state. While dynamically stable, the mobile robot 100 may use sensor information to make small pose adjustments as needed to remain balanced. Furthermore, the feet 116a, 116b may be planted on the ground surface 300 during one some or all of these portions of the method 400. Still further, the planes 306a, 306b can be within 15 degrees (e.g., within 10 degrees) of parallel to one another during one, some, or all of these portions of the method 400. Correspondingly, when the planes 306a, 306b are not parallel to one another, the counterparts of the plane 306c corresponding the legs 112a, 112b, respectively, can be within 15 degrees (e.g., within 10 degrees) of parallel to one another during one, some, or all of these portions of the method 400.

In at least some cases, the method 400 occurs while the mobile robot 100 is in an environment that also includes a human. Examples of this environment include warehouses, order-fulfilment centers, stockrooms, and retail centers, among many others. In general, examples of the method 400 can be useful in any environment in which the mobile robot 100 and a human are in close enough proximity that operation of the mobile robot 100 corresponds to a safety hazard for the human absent adequate hazard mitigation. Moreover, the method 400 can be useful even in segregated environments. For example, the method 400 may be useful to reduce hazards to humans who service mobile robots that would otherwise be segregated from humans in an environment. In these and other cases, aspects of the method 400 can be based at least partially on hazard information about the human.

In an example, the method 400 includes determining first hazard information about a human in the environment at a first time while the mobile robot 100 is in the standing state and before moving the mobile robot 100 from the standing state to the non-standing state. The method 400 can include moving the mobile robot 100 to the non-standing state at least partially in response to the first hazard information. Determining the first hazard information can occur via the computer system. Furthermore, determining the first hazard information can occur while the mobile robot 100 is dynamically stable. In connection with determining the first hazard information, the method 400 can include sensing the human. The mobile robot 100 can capture sensor data corresponding to the human via one or more sensors. The captured sensor data can include LiDAR (Light Detection and Ranging) data, stereoscopic data, RGB (Red, Green, Blue) data, SONAR (Sound Navigation and Ranging) data, and/or data of one or more other suitable types. In at least some cases, the method 400 includes pre-processing the sensor data, such as by filtering irrelevant data and/or by fusing relevant data from two or more different sensing modalities.

Sensing the human can include sensing a presence of the human and/or sensing a variable related to the human. Examples of such variables include location, trajectory, speed, and state (e.g., encumbered, unencumbered, alert, distracted, etc.). Location, trajectory, and/or certain other location-related variables corresponding to the human can be relative to a reference frame in which the mobile robot 100 also determines its own location. In at least some cases, the first hazard information includes a proximity of the human to the mobile robot 100 at the first time. In addition or alternatively, the first hazard information can include a trajectory of the human at the first time. Also in addition or alternatively, the first hazard information can include a speed of the human at the first time. Also in addition or alternatively, the first hazard information can include a state of the human at the first time.

The method 400 can include processing sensor data on a human via a suitable algorithm and/or model. As an example, the method 400 can include processing the sensor data via a SLAM (Simultaneous Localization and Mapping) algorithm. In connection with this processing and/or in another context, the method 400 can include sensing different locations of the human at different respective times and using the locations along with an elapsed time between the sensing instances to determine a velocity of the human. Relatedly, the method 400 can include providing sensor data to a machine-learning model (e.g., a convolutional neural network) trained to recognize humans and/or human states. As an example, the method 400 can include providing raw sensor data on the environment to a first machine-learning model trained to separate human-related data from extraneous data. An example of this first model is YOLOV8 (Ultralytics Inc.). The method can then include providing human-related data from the first model to a second model trained to determine human states based on the human-related data. An example of this second model is AMAZON REKOGNITION (Amazon Web Services, Inc.). Moreover, sensing the location, trajectory, speed, state, and/or other variables related to the human can make use of the same or different sensor data.

Moving the mobile robot 100 to the non-standing state can reduce a risk of the mobile robot 100 injuring the human. For example, moving the mobile robot 100 to the non-standing state can reduce a fault-state fall extent of the mobile robot 100 (e.g., by at least 30%, by at least 50%, etc.). Fault-state fall extent is a maximum distance in which contact with the mobile robot 100 is possible upon and/or shortly after a fault event. The fault-state fall extent of the mobile robot 100 can be defined in a plane parallel to a ground plane under the mobile robot 100 and further defined relative to a vertical reference line that approximates a center of the mobile robot 100. In general, a fault event is a transition of the mobile robot 100 from a non-fault state (e.g., a regular state, a working state, an uninterrupted state, a functional state, a non-disabled state, etc.) to a fault state (e.g., an irregular state, a non-working state, an interrupted state, a non-functional state, a disabled state, etc.). In practice, the transition can occur by default or in response to a command. Furthermore, the transition can occur in conjunction with loss of power to the mobile robot 100, loss of connectivity with the mobile robot 100, and/or breach of a boundary around the mobile robot 100, among other examples.

The method 400 can further include determining second hazard information about the human at a second time while the mobile robot 100 is in the non-standing state and before moving the mobile robot 100 from the non-standing state to the standing state. The method 400 can include moving the mobile robot 100 to the standing state at least partially in response to the second hazard information. Determining the second hazard information can occur via the computer system. Furthermore, determining the second hazard information can occur while the mobile robot 100 is dynamically stable. In connection with determining the second hazard information, the method 400 can include sensing the human in the same or a different manner than described above for the first hazard information. Relatedly, the type of the second hazard information can be the same as or different from the type of the first hazard information. For example, this second hazard information can include a proximity of the human to the mobile robot 100, a trajectory of the human, a speed of the human, and/or a state of the human. In at least some cases, the second hazard information indicates a reduction in a safety risk to the human relative to a risk corresponding to the first hazard information. For example, the second hazard information may include an indication that a distance between the human and the mobile robot 100 is above a threshold.

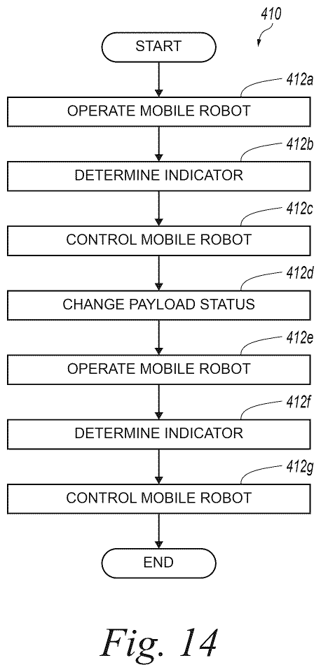

FIG. 14 is a block diagram corresponding to another method 410 in accordance with at least some embodiments of the present technology. The diagram includes blocks 412a-412g corresponding to different respective portions of the method 410. Features of the method 410 are described herein primarily in the context of the mobile robot 100. It should be understood, however, that various examples of the method 400 can be implemented in accordance with other mobile robots. Furthermore, suitable aspects of the method 410 can be implemented at least partially via a computer system (not shown) operably associated with the mobile robot 100. Where aspects of the method 410 are described herein as performed by the mobile robot 100, it should be understood that these descriptions include performing such aspects entirely or partially by the computer system. Further details regarding various examples of the computer system are provided below in the context of FIGS. 19 and 20. The mobile robot 100 can carry the computer system. Alternatively, all or a portion of the computer system can be remote and operably associated with the mobile robot 100 via suitable communication hardware.

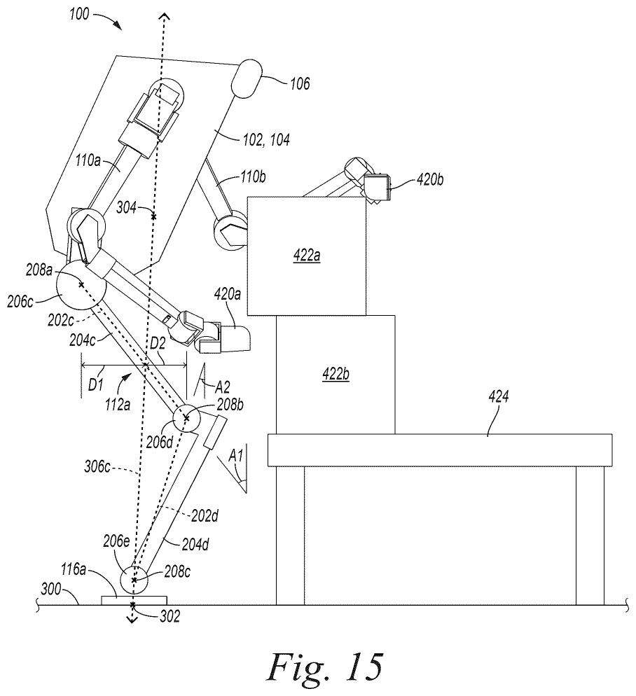

FIGS. 15-18 are profile views of the mobile robot 100 at different respective times during an example of the method 410. In this example, the mobile robot 100 includes end effectors 420a, 420b in place of the end effectors 114a, 114b described above. In contrast to the pincer form of the end effectors 114a, 114b, the end effectors 420a, 420b have a three-dimensional paddle form well suited for interaction with cuboid objects. In FIGS. 15-18, the mobile robot 100 is shown in an environment including objects 422a, 422b stacked on a table 424. With reference to FIGS. 1-14 together, the method 400 can include operating the mobile robot 100 (block 412a) at a first time. This can include operating the mobile robot 100 in a dynamically stable state. Furthermore, operating the mobile robot 100 at the first time can include ambulating the mobile robot 100, such as bipedally via the legs 112a, 112b. Furthermore, operating the mobile robot 100 at the first time can include standing the mobile robot 100, such as bipedally via the legs 112a, 112b. Furthermore, operating the mobile robot 100 at the first time can include carrying a payload, such as bipedally via the arms 110a, 110b. When the mobile robot 100 carries a payload (e.g., the object 422a), the mobile robot 100 and the payload can define the center of gravity 304 collectively. Correspondingly, when the mobile robot 100 picks up a payload, the plane 306c can shift toward the payload. Likewise, when the mobile robot 100 sets down a payload, the plane 306c can shift away from the payload. The method 400 can include using this information to inform kinematics of the mobile robot 100 to promote the objective discussed above of balancing loads on the knee and hip actuators.

The method 410 can further include determining an indicator of a position of the link 204c relative to the plane 306c and/or an indicator of a position of the link 254c relative to the plane 306c (block 412b). For clarity of explanation, indicators corresponding to the links 204c, 254c will be described together based on the links 204c. It should be understood however, that the plane 306c can have separate, different counterparts for the links 204c, 254c, respectively, and that these counterparts can be the basis for separate indicators corresponding to the links 204c, 254c, respectively. The indicator can be a numerical value representing the distance between the plane 306c and a reference point on the link 204c, such as its midpoint or endpoint. In some cases, the indicator may be an angle formed between the plane 306c and the longitudinal axis of the link 204c. Alternatively, the indicator could be a vector describing the relative orientation and position of the link 204c with respect to the plane 306c. In other implementations, the indicator may be a ratio comparing the lengths of the portions of the link 204c on either side of the plane 306c. The indicator could also be a boolean value indicating whether the plane 306c intersects the link 204c within a predetermined range along its length. In some aspects, the indicator may be a set of coordinates defining the intersection point between the plane 306c and the link 204c. Additionally, the indicator could be a percentage value representing how far along the length of the link 204c the plane 306c intersects.

With reference again to the illustrated embodiment, the method 410 can further include controlling the mobile robot 100 based at least partially on the indicator (block 412c). This can include any form of control related to promoting balancing of loads on the knee and hip actuators. In at least some cases, the control includes providing the indicator to a kinematic solver of the computer system (as discussed in the context of FIG. 19 below). The kinematic solver can be configured to change a pose of the mobile robot 100 in a way that promotes balancing of loads on the knee and hip actuators. For example, kinematic solver can have an objective to reduce a difference between D1 and D2. In these and other cases, controlling the mobile robot 100 can further include changing a pose of the mobile robot 100 based at least partially on an output of the kinematic solver. This can cause an average intersection of the plane 306c and the length of the link 204c while operating the mobile robot 100 to be within a middle 25% (e.g., a middle 15%) of the length of the link 204c. This and other averages during operation of the mobile robot 100 can be based on continuous periods of operation of the mobile robot 100 in a dynamically stable state without payload change. For example, the periods can be for at least 5 seconds, at least 10 seconds, at least 20 seconds, etc.

The method 410 can further include changing a payload status of the mobile robot 100 (block 412d) after operating the mobile robot 100 at the first time. As discussed above, changing the payload status (e.g., picking up a payload or placing a payload) can cause a large and sudden shift in the center of gravity 304 and, correspondingly, in the plane 306c. The magnitude of this shift can be related to the mass of the payload and the distance of the payload from the center of gravity 304 immediately before the change. In at least some cases, the mass of the payload is at least 5 kg (e.g., at least 10 kg, at least 15 kg, etc.) such that the shift is relatively pronounced. After changing the payload status, the method 410 can include operating the mobile robot 100 (block 412e), determining the indicator (block 412f), and controlling the mobile robot 100 (block 412g). These portions of the method 410 can include any suitable features described above for the corresponding portions of the method 410 before changing the payload status. For example, when the mobile robot 100 is carrying a payload before changing the payload status, the indicators before and after changing the payload status can be based on the center of gravity 304 with and without the payload, respectively. Similarly, when the mobile robot 100 is not carrying a payload before changing the payload status, the indicators before and after changing the payload status can be based on the center of gravity 304 without and with the payload, respectively.

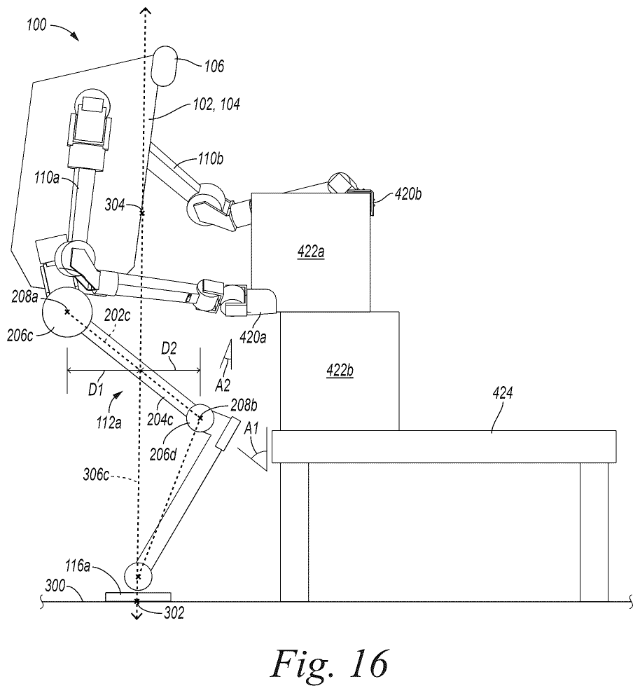

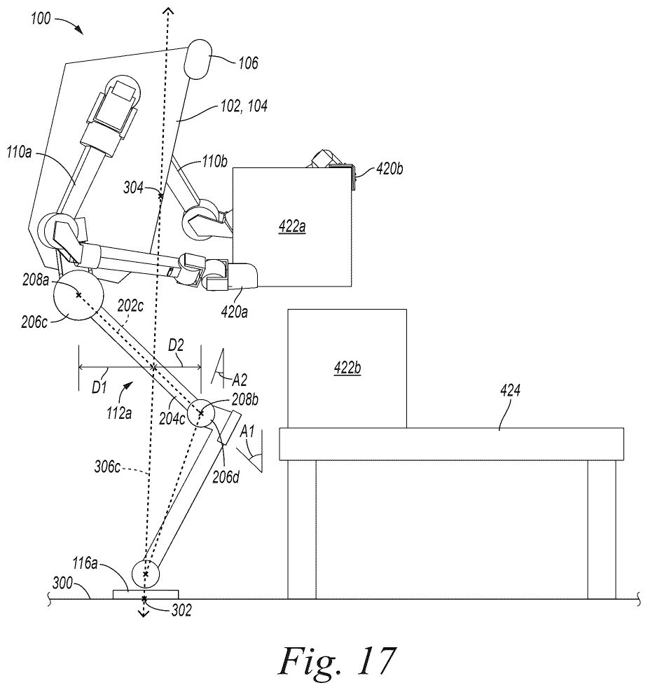

FIGS. 15-17 illustrate one example of a payload status change. FIG. 15 shows operation of the mobile robot 100 at a first time when the mobile robot 100 is not carrying a payload. FIG. 16 shows a second time immediately after a payload status change when the mobile robot 100 transitions to carrying a payload (i.e., the object 422a in the illustrated example). The payload status change can cause the center of gravity 304 and the plane 306c to shift toward the object 422a. This can move D1 and D2 away from equilibrium. In the illustrated case, D1 becomes much larger than D2, corresponding to an increase in a load on the actuator corresponding to the joint 206c and a decrease in a load on the actuator corresponding to the joint 206d. FIG. 16 corresponds to operating and controlling the mobile robot 100 at the second time after the payload status change. This can include moving the body 102 away from the payload, flexing the leg 112a, increasing the angle A1, and/or increasing the angle A2, among other shifts that tend to at least partially offset the effect of the payload change on the balancing of loads on the knee and hip actuators. As shown in FIG. 17, further shifts can occur shortly after the payload status change. For example, in conjunction with moving the payload toward the body 102, the mobile robot 100 can move the body 102 toward the payload, extend the leg 112a, decrease the angle A1, and/or decrease the angle A2.

As described above, the payload status change shown in FIGS. 15-17 is related to picking up the object 422a. Thus, this method 410 in the example shown in FIGS. 15-17 can include operating the mobile robot 100 at a first time without a payload, retrieving a payload, and then operating the mobile robot 100 at a second time with the payload. While operating the mobile robot 100 at the first and second times, the method 410 can include accounting for the effect of the payload on load balancing between the knee and hip actuators. In these and other cases, the method 410 can include more than one payload status change. For example, the method 410 can include placing the payload (e.g., the object 422a) and then operating the mobile robot 100 at a third time without the payload. Again, controlling the mobile robot 100 can include pose adjustments that account for the effect of the payload status change on the center of gravity 304. Furthermore, in the illustrated example, the mobile robot 100 carries the payload at an anterior side of the body 102 along an anterior-posterior dimension defined by the mobile robot 100. Relatedly, controlling the mobile robot 100 at the first and second times can include causing the body 102 to have first and second average positions, respectively, in the anterior-posterior dimension with the second average position being more posterior along the anterior-posterior dimension than the first average position. Similarly, controlling the mobile robot 100 at the third time can include causing the body 102 to have a third average position in the anterior-posterior dimension that is more anterior along the anterior-posterior dimension than the second average position. The relative magnitudes of these and other kinematic adjustments of the mobile robot 100 can be proportional to the properties of the payload (e.g., the mass).

In some aspects, the mobile robot 100 may adjust its pose to achieve a load balancing objective between actuators, such as between knee and hip actuators. This adjustment may be performed continuously or at regular intervals during operation, such as when transitioning between standing and non-standing states, when changing payload status, etc. The load balancing objective may involve maintaining a coronal or quasi-coronal plane (e.g., the plane 306c) within a middle portion (e.g., a middle 25%, a middle 15%, etc.) of the length of a thigh link (e.g., the link 204c). This positioning may help distribute loads more evenly between the hip actuator associated with the hip joint 206c and the knee actuator associated with the knee joint 206d. In some implementations, the mobile robot 100

As discussed in more detail below, the mobile robot 100 may use sensor data to determine its current pose and the current load distribution on its actuators. This sensor data may come from joint position sensors, force/torque sensors at the joints, inertial measurement units (IMUs), or other suitable sensors. The mobile robot 100 may then use this information to calculate an indicator of the position of the link 204c relative to the plane 306c. The indicator may take various forms. In some cases, it may be a ratio of the distance between the hip joint and the intersection of the plane 306c with the link 204c to the distance between the knee joint and this intersection. In other cases, it may be an angle formed between the plane 306c and the length of the link 204c. The mobile robot 100 may aim to keep this indicator within a predetermined range that corresponds to balanced loading of the hip and knee actuators. Upon determining that the indicator is outside the desired range, the mobile robot 100 may adjust its pose. This adjustment may involve changing the angles of multiple joints, not just the hip and knee joints of the leg in question. For example, the mobile robot 100 may adjust the position of its torso, the angles of its other leg, or even the position of its arms (especially if it is carrying a heavy payload). These adjustments may be calculated using inverse kinematics algorithms that take into account the desired indicator value as well as other constraints, such as stability and task requirements.

In some implementations, the mobile robot 100 may use machine learning models to predict optimal or near-optimal joint configurations for maintaining the load-balancing indicator within the desired range. These models may be trained on data collected during the robot's operation, allowing them to adapt to the specific characteristics of the mobile robot 100 and its typical tasks. The pose adjustment process may be particularly useful when the mobile robot is retrieving or placing a payload or when it is transitioning between standing and non-standing states. In these situations, the center of gravity of the robot may shift significantly, potentially causing large changes in the loading of different actuators. By continuously adjusting its pose to maintain the load balancing indicator within the desired range, the mobile robot 100 can promote more even distribution of loads across its actuators, potentially improving efficiency and reducing wear on the actuators. Relatedly, the mobile robot 100 may prioritize poses that reduce (e.g., minimize) differences between loads on the hip and knee actuators. This prioritization may be implemented as part of the robot's motion planning algorithms, ensuring that load balancing is considered alongside other objectives such as stability and task completion.

### Examples of Electrical, Computer, and Software Systems

FIG. 18 is a block diagram depicting a system 500 including electrical, computer, and software features operably associated with a mobile robot in accordance with at least some embodiments of the present technology. The system 500 may be described in the context of the mobile robot 100 as an example. When suitable, operations described elsewhere in this disclosure can be implemented at least partially via the devices and systems disclosed in this section. For example, the computer system discussed above in the connection with the method 400 can be part of the system 500. As shown in FIG. 20, the system 500 can include computing features 502. The computing features 502 can include a processor 504, such as one or more general-purpose or special-purpose integrated circuits including digital logic gates for executing programs or for otherwise processing data. The computing features 502 can further include memory 506, such as one or more integrated circuits for storing data in use. The memory 506 can include a multithreaded program, an operating system including a kernel, device drivers, etc. The computing features 502 can further include persistent storage 508, such as a hard drive for persistently storing data. Examples of data that can be stored by the persistent storage 508 include diagnostic data, sensor data, configuration data, environmental data, and current-state data. The computing features 502 can collectively define a computer configured to manage, control, receive information from, deliver information to, and/or otherwise usefully interact with other features of the system 500.

The system 500 can further include communication features 510. The communication features 510 can include a computer-readable media drive 512 for reading computer programs and/or other data stored on computer-readable media. As one example, the computer-readable media drive 512 can be a flash-memory drive. The communication features 510 can further include a network connection 514 for connecting the mobile robot 100 to other devices and systems, such as other mobile robots and/or other computer systems. The network connection 514 can be wired or wireless and can be via the Internet, a Local Area Network (LAN), a Wide Area Network (WAN), BLUETOOTH®, Wi-Fi®, a cellular-phone network, etc. The network connection 514 can include networking hardware, such as routers, switches, transmitters, receivers, computer-readable transmission media, etc. The communication features 510 can further include a display 515 (e.g., a touchscreen) and/or other suitable features for communicating with a user. The mobile robot 100 can use the communication features 510 for internal and/or external operations. Examples of these operations include interacting with systems that provide contextual information about the environment in which the mobile robot 100 operates and interacting with systems for changing operating conditions of the mobile robot 100.

The system 500 can further include electromechanical features 516. The electromechanical features 516 can include arm actuators 518 and leg actuators 520 operably associated with respective joints of the arms 110a, 110b and the legs 112a, 112b. In addition or alternatively, the electromechanical features 516 can include other suitable features for implementing mechanical action within the mobile robot 100. As shown in FIG. 18, the system 500 can further include power features 522, such as a battery 524 and a charger 526. The battery 524 can be a lithium-ion battery, a sodium-ion battery, or a battery of another suitable type. The charger 526 can include a connector (not shown) compatible with a power source (e.g., a wall outlet, a charging station, etc.) and leads extending between the connector and the battery 524. In at least some cases, the mobile robot 100 is configured to operate wirelessly via the battery 524 and to recharge via the charger 526.

Finally, the system 500 can include sensor features 528 for capturing, providing, and/or analyzing information about the mobile robot 100 itself and/or the environment in which the mobile robot 100 operates. The sensor features 528 can include a vision sensor (e.g., a camera), a light sensor (e.g., a photoresistor), a sound sensor (e.g., a microphone), a location sensor (e.g., a Global Positioning System (GPS) sensor), a two-dimensional sensor, a three-dimensional sensor, and/or a proximity sensor, among other examples. Within the body 102 and/or at one or more other suitable locations, the mobile robot 100 can include among the sensor features 528, an accelerometer, a gyroscope, a magnetometer, and/or a tilt sensor, among other examples. At the end effectors 114a, 114b, at the feet 116a, 116b, and/or at one or more other suitable locations, the mobile robot 100 can include among the sensor features 528, a contact sensor and/or a force sensor. In at least some cases, two or more different types of sensors are incorporated into a sensor assembly of the mobile robot 100. For example, an accelerometer, a gyroscope, and a magnetometer or another suitable combination of sensors can be incorporated into an inertial measurement unit (IMU) through which the mobile robot 100 can determine parameters such as acceleration, angular velocity, and orientation. The mobile robot 100 can include an IMU within the torso 104, within the head 106, and/or at one or more other suitable locations.

At one, some, or all of the arm actuators 518, at one, some, or all of the leg actuators 520, and/or at one or more other suitable locations, the mobile robot 100 can include among the sensor features 528, sensors that measure properties of corresponding joints. Such properties can include position, orientation (e.g., yaw, pitch, and roll), applied force (e.g., torque), elevation, mass, velocity, and acceleration, among other examples. The measurements of these properties can be direct or indirect. As an example of direct sensing, the mobile robot 100 may sense a torque acting on a given joint via a torque sensor operably associated with the joint, such as a torque sensor that outputs torque as function of current. As another example of direct sensing, the mobile robot 100 may sense a position of a given joint via an encoder operably associated with the joint. Any joint described herein should be construed as potentially including a torque sensor, encoder, and/or other suitable mechanism for direct sensing. As an example of indirect sensing, the mobile robot 100 may sense a position of a given one of the end effectors 114a, 114b or other feature based on perception data corresponding to the feature and other data corresponding to a reference. The mobile robot 100 can include one or more sensors in a sensor system, such as a vision system, a LiDAR system, a stereoscopic camera system, a SONAR system, etc. In at least some cases, the mobile robot 100 monitors itself and/or its environment in real-time or in near real-time. Moreover, the mobile robot 100 may use acquired sensor data as a basis for decision-making via the computing features 502.

Features of the system 500 can be connected to one another and/or to other features of the mobile robot 100 via suitable conductors, transmitters, receivers, circuitry, etc. While the system 500 configured as described may be used to support operation of the mobile robot 100, it should be appreciated that the mobile robot 100 may be operated using devices of various types and configurations and that such devices may have various components and levels of responsibility. For example, the mobile robot 100 may employ individual computer systems and/or controllers to manage discrete aspects of its operations, such as an individual computer system or controller to perform computer vision operations, a separate computer system or controller to perform power management, etc. In some cases, the mobile robot 100 employs the system 500 to control physical aspects according to one or more designated rules encoded in software. For example, these rules can include minimums and/or maximums, such as a maximum degree of rotation for a joint, a maximum speed at which a link is allowed to move, a maximum acceleration rate for the feet 116a, 116b, etc. The mobile robot 100 may include any number of mechanical aspects and associated rules, which may be based on or otherwise configured in accordance with the purpose of and/or functions performed by the mobile robot 100.

Software features of the system 500 and other computer systems described herein may take the form of computer-executable instructions, such as program modules executable by the computing features 502. Generally, program modules include routines, programs, objects, data structures, or the like configured to perform particular tasks based on source data, which may be encrypted. Control scripts may be implemented via a suitable language, such as C/C++ or Python®. The functionality of the program modules may be combined or distributed in various embodiments, including in cloud-based implementations. Furthermore, certain aspects of the present technology can be embodied in special purpose computers or data processors, such as in application-specific integrated circuits (ASIC), digital signal processors (DSP), field-programmable gate arrays (FPGA), graphics processing units (GPU), many core processors, etc. specifically programmed, configured, or constructed to perform one or more computer-executable instructions. While aspects of the present technology, such as certain functions, may be described as being performed on a single device, these aspects, when suitable, can also be practiced in distributed computing environments where functions or modules are shared among different processing devices linked through a communications network such as a LAN, a WAN, or the Internet. In a distributed computing environment, program modules and other features may be located in both local and remote memory storage and in other devices, which may be in communication via one or more wired or wireless communication channels.

Aspects of the present technology may be stored or distributed on tangible computer-readable media, which can include volatile or non-volatile storage features, such as magnetically or optically readable computer media, hard-wired or preprogrammed chips (e.g., electrically erasable programmable read-only memory semiconductor chips), nanotechnology memory, or other computer-readable storage media. Alternatively, computer-implemented instructions, data structures, screen displays, and other data under aspects of the present technology may be distributed (encrypted or otherwise) over the Internet or over other networks (including wireless networks) on a propagated signal on a propagation medium (e.g., electromagnetic wave(s), sound wave(s), etc.) over a period of time. Furthermore, such data may be provided on an analog or digital network and packet switched, circuit switched, or managed under another suitable scheme. The term computer-readable storage medium as used herein does not, however, encompass signals themselves (e.g., propagating signals) or transitory media. One of ordinary skill in the art will recognize that various features of the mobile robot 100 and other devices and systems described herein may communicate via any number of wired or wireless communication techniques and that elements of such devices and systems may be distributed rather than located in a single monolithic entity. Finally, electrical and computing aspects of systems in accordance with various embodiments of the present technology may operate in environments or according to processes other than the examples of environments and processes described herein.

FIG. 19 is a block diagram depicting software architecture 550 and associated portions of the system 500. The software architecture 550 can be within the memory 506 or otherwise operably associated with any or all of the various features of the system 500 as described above. With reference to FIGS. 18 and 19 together, the software architecture 550 can include a planning module 552, an estimating module 554, and an execution module 556 operably associated with one other. The planning module 552 can be configured to relay or to generate a plan corresponding to an objective for the mobile robot 100 (e.g., unload all objects on a shelf, retrieve an object from a first location and move the object to a second location, etc.). In at least some cases, the planning module 552 receives information from the communication features 510 of the system 500 and relays or generates a plan based at least partially on the received information. For example, the planning module 552 may receive a task request from a user via the communication features 510 and relay the task request as a plan. As another example, the planning module 552 may receive a task request from a user via the communication features 510 and generate a plan related to the task request. As yet another example, the planning module 552 may generate a plan without receiving a task request from a user, such as at a predetermined time and/or in response to information about a current state of the mobile robot 100 or the environment received via the sensor features 528 of the system 500.

The estimating module 554 can receive information from the sensor features 528 and generate estimates in real time or in near real time to inform generating and/or executing a plan. The estimating module 554 can include a robot kinematic estimator 558, a robot position estimator 560, an object estimator 562, and a world state 564. The robot kinematic estimator 558 can generate an estimate of a current kinematic state of the mobile robot 100 (e.g., balanced, off-balance, walking, standing, etc.) and estimates of positions of individual joints of the mobile robot 100. The robot position estimator 560 can generate a current estimate of a position of the mobile robot 100 within an environment. This position can be a set of coordinates and can be based on perception information, GPS information, and/or other information received by or generated by the mobile robot 100. Perception information potentially relevant to the position of the mobile robot 100 includes, among other examples, information corresponding to distances between the mobile robot 100 and landmarks in an environment and information corresponding to fiducial markings (e.g., AprilTags) carried by or otherwise associated with the landmarks. This information can be detected, for example, via a camera of the mobile robot 100. Furthermore, information can move between components of the estimating module 554. For example, the world state 564 can receive information from the robot kinematic estimator 558, the robot position estimator 560, and the object estimator 562. In addition or alternatively, the object estimator 562 can receive information from the robot kinematic estimator 558 and the robot position estimator 560.

The object estimator 562 can generate a current estimate of an object within an environment. In at least some cases, the estimate is a pose or other reference corresponding to a position and orientation of the object. As with the position of the mobile robot 100 itself, the position of an object can be a set of coordinates and can be based on perception information, GPS information, and/or other information received by or generated by the mobile robot 100. Perception information potentially relevant to the position of an object includes, among other examples, information corresponding to distances between the object and the mobile robot 100, distances between the object and landmarks in an environment, and information corresponding to fiducial markings (e.g., AprilTags) carried by or otherwise associated with the object. This information can be detected, for example, via a camera of the mobile robot 100. In at least some cases, the object estimator 562 uses information (e.g., sensor poses) from the robot kinematic estimator 558 and/or the robot position estimator 560 to inform generation of object estimates. This can be useful, for example, when a fiducial or other landmark in an environment is not visible. The object estimator 562 can be configured to update the world state 564 with object references and/or other information related to objects in an environment in which the mobile robot 100 operates. Furthermore, the object estimate can include an identification of an object and properties (e.g., dimensions) associated with that identification. For example, the object estimator 562 can include an object-recognition model (e.g., Detectron2 (Facebook AI Research) with Mask R-CNN implementation) that receives perception information (e.g., an image) corresponding to an object and outputs an object identification based at least partially on the perception information. The object estimator 562 can further include a lookup table for generating object properties based at least partially on this object identification.

The execution module 556 can be configured to receive a plan from the planning module 552 and estimates from the estimating module 554. The plan can include one or more motion commands and/or motion-command precursors as discussed above in connection with examples of the method 400. The execution module 556 can include an object sequencing module 566, a manipulation selection module 568, a robot navigation module 570, and a joint configuration module 572. The planning module 552 can be configured to send a plan to the object sequencing module 566, to the manipulation selection module 568, to the robot navigation module 570, or to the joint configuration module 572 based on attributes of the plan. For example, when a plan includes explicit instructions for positions of the electromechanical features 516 of the system 500, the planning module 552 can send the plan to the execution module 556 via the joint configuration module 572. As another example, when a plan does not involve manipulating an object, the planning module 552 can send the plan to the execution module 556 via the robot navigation module 570. As yet another example, when a plan concerns only one object and the object is remote to the mobile robot 100, the planning module 552 can send the plan to the execution module 556 via the manipulation selection module 568. As a final example, when a plan concerns multiple objects remote to the mobile robot 100, the planning module 552 can send the plan to the execution module 556 via the object sequencing module 566.

The object sequencing module 566 can receive one or more estimates from the estimating module 554 and can generate a sequence in which multiple objects are to be manipulated. For example, when the object sequencing module 566 receives a plan to unload a shelf, the object sequencing module 566 can query the estimating module 554 for current locations of objects on the shelf. The object sequencing module 566 can then assign the objects an order, convert the order into a queue, and pass the queue to the manipulation selection module 568. The manipulation selection module 568 can include a library 574 including manipulation primitives and/or sequences of manipulation primitives that can be used to manipulate an object. The manipulation selection module 568 can select manipulation primitives and/or sequences for a given object based on contextual information, such as information about the object and/or information about the environment. In addition or alternatively, the manipulation selection module can include a model 575 that outputs manipulation estimates based on contextual information. The robot navigation module 570 can generate targets for different parts of the mobile robot 100 further to a manipulation portion or other portions of a plan being executed. Examples of targets include positions of the feet 116a, 116b in the environment, positions of the end effectors 114a, 114b in the environment, etc. The robot navigation module 570 can update these targets continuously or near continuously based on information from the estimating module 554. The execution module 556 can further include an inverse kinematics module 576 that translates the targets from the robot navigation module 570 into joint configurations throughout the mobile robot 100.

In at least some cases, software components of the computer system discussed above in connection with the method 400 are implemented in the software architecture 550 via the execution module 556, such as via the robot navigation module 570. For example, the robot navigation module 570 may generate targets for different parts of the mobile robot 100 that promote one or more load-balancing objectives (e.g., even balancing of loads on actuators operably associated with the joints 206c, 206d, respectively, and/or even balancing of loads on actuators operably associated with the joints 256c, 256d, respectively). This can be based on one or more algorithms, heuristics, formulas, models, etc. corresponding to the one or more load-balancing objectives. Furthermore, information from the estimating module 554 may inform this operation of the robot navigation module 570. The estimating module 554 may use information from the sensor features 528 to generate estimates of the center of gravity 304, the plane 306c, and/or one or more other properties of the mobile robot 100 relevant to the one or more load-balancing objectives. Furthermore, these estimates may be static, quasi-static, or dynamic. For example, when the mobile robot 100 is in motion, the estimating module 554 may determine an acceleration of the center of gravity 304 along with a position of the center of gravity 304. The robot navigation module 570 can then use the acceleration of the center of gravity 304 and/or the position of the center of gravity 304 to generate appropriate targets for parts of the mobile robot 100 that promote one or more load-balancing objectives.

In at least some cases, the estimating module 554 uses information from the sensor features 528 about a payload carried by the mobile robot 100 in connection with generating estimates of the center of gravity 304, the plane 306c, and/or one or more other properties of the mobile robot 100 relevant to a load-balancing objective. In these and other cases, the mobile robot 100 may include force sensors at the end effectors 114a, 114b, respectively. The estimating module 554 may use information from these force sensors and/or other sensors to determine information about a payload. In a particular example, information from the force sensors at the end effectors 114a, 114b indicates a presence of a payload, information from a vision sensor of the mobile robot 100 indicates a position of the payload, and information from the same or a different vision sensor of the mobile robot 100 indicates an object type of the payload. With this information, the estimating module 554 can determine a mass of the payload (e.g., via a lookup table correlating mass to object type) and use this mass along with the position of the payload to determine an appropriate shift of the center of gravity 304 corresponding to the presence of the payload. The robot navigation module 570 can then use this information to generate targets for parts of the mobile robot 100 that promote one or more load-balancing objectives.

The execution module 556 can also include a control module 578 that receives joint configurations from the inverse kinematics module 576 and generates joint parameters (e.g., positions, velocities, accelerations, etc.) to be executed by the mobile robot 100 via the electromechanical features 516 of the system 500 to achieve these joint configurations. Through continuous or near-continuous communication with the inverse kinematics module 576, the control module 578 can modify the joint parameters to at least partially compensate for deviations as the mobile robot 100 executes the joint configurations. The inverse kinematics module 576 can send other joint configurations not subject to active control to the joint configuration module 572 directly. Similar to the control module 578, the joint configuration module 572 can generate joint parameters (e.g., positions, velocities, accelerations, etc.) to be executed by the mobile robot 100 to achieve joint configurations received from the inverse kinematics module 576 or from the planning module 552.

Finally, the execution module 556 can include an inverse dynamics module 580 that receives joint parameters from the control module 578 and from the joint configuration module 572. The inverse dynamics module 580 can track a desired wrench of the mobile robot 100 and its relationship with objects in the environment. In at least some cases, the inverse dynamics module 580 references a map of robot positions and wrenches to joint torques. Based at least partially on tracking these joint torques, the inverse dynamics module 580 can modify joint parameters to achieve a desired result. For example, the inverse dynamics module 580 may modify joint parameters from the control module 578 and from the joint configuration module 572 to maintain contact between the end effectors 114a, 114b and an object as the mobile robot 100 carries the object. The inverse dynamics module 580 can then send modified joint parameters to the electromechanical features 516 of the system 500 for execution. For configurations that do not involve dynamic interaction with the environment, the control module 578 and the joint configuration module 572 can send joint parameters directly to the electromechanical features 516 for execution.

With reference to FIGS. 18 and 19 together, suitable software components disclosed herein can be part of a distributed system or component thereof or implemented as one or more network-based services. For example, a compute cluster within a computing service may present computing or storage services or other types of services that employ any distributed computing systems described herein to clients as network-based services. In some embodiments, a network-based service may be implemented by a software or hardware system designed to support interoperable machine-to-machine interaction over a network. A network-based service may have a gateway described in a machine-processable format. Other systems may interact with the network-based service in a manner prescribed by the description of the network-based service's gateway. For example, the network-based service may define various operations that other systems may invoke. Relatedly, the network-based service may define a particular API to which other systems may be expected to conform when requesting the various operations. In the cloud provider network context, APIs may provide a gateway for customers to access cloud infrastructure by allowing customers to obtain data from and/or to cause actions within the cloud provider network, enabling the development of applications that interact with resources and services hosted in the cloud provider network. APIs can also enable different services of the cloud provider network to exchange data with one another.

In a distributed system, some or all of the software architecture 550 and other software described herein can be executed remotely from the mobile robot 100. For example, the mobile robot 100 can be configured to collect raw sensor data via the sensor features 528 of the system 500 and to transmit some or all of this raw sensor data to a remote server in real time or near real time for processing. The mobile robot 100 can then receive joint commands and/or other products of this processing via communication with the server. In these and other cases, computing operations can be allocated among local and remote computing systems depending on factors such as computing demand, available computing resources, time sensitivity of computing products, etc. Moreover, even the sensor features 528 can be remote from the mobile robot 100 in certain cases. For example, a remote sensor may track its reference frame relative to a local sensor of the mobile robot 100 and may communicate that reference frame with sensor data it collects at any given time. A server receiving the sensor data can then use the relationship between the reference frame of the local sensor and the reference frame of the remote sensor to generate output in a reference frame compatible with processes that rely on sensor data from the local sensor only. Alternatively, in a non-distributed system, all information processing and command execution can occur locally at the mobile robot 100 or other local hardware depending on the implementation.

### Conclusion

This disclosure is not intended to be exhaustive or to limit the present technology to the precise forms disclosed herein. Although specific embodiments are disclosed herein for illustrative purposes, various equivalent modifications are possible without deviating from the present technology, as those of ordinary skill in the relevant art will recognize. In some cases, well-known structures and functions have not been shown or described in detail to avoid unnecessarily obscuring the description of the embodiments of the present technology. Although steps of methods may be presented herein in a particular order, in alternative embodiments the steps may have another suitable order. Similarly, certain aspects of the present technology disclosed in the context of particular embodiments can be combined or eliminated in other embodiments. Furthermore, while advantages associated with certain embodiments may be disclosed herein in the context of those embodiments, other embodiments may also exhibit such advantages, and not all embodiments need necessarily exhibit such advantages or other advantages disclosed herein to fall within the scope of the present technology. This disclosure and the associated technology can encompass other embodiments not expressly shown or described herein.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the terms “generally,” “substantially,” “about,” and similar terms are used as terms of approximation and not as terms of degree, and are intended to account for the inherent variations in measured or calculated values that would be recognized by those of ordinary skill in the art. Additionally, the terms “comprising,” “including,” “having,” and the like are used throughout this disclosure to mean including at least the recited feature(s) such that any greater number of the same feature(s) and/or one or more additional types of features are not precluded. This is the case even if a particular number of features is specified unless that specified number is preceded by the word “exactly” or another clear indication that it is intended to be closed ended. In a particular example, “comprising two arms” means including at least two arms. References herein to any of receiving, determining, generating, and selecting information in accordance with various embodiments of the present technology encompass, when feasible, the others of receiving, determining, generating, and selecting the information and indicate that such operations can occur at least partially via the relevant computing subsystem.

Directional terms, such as “upper,” “lower,” “front,” “back,” “vertical,” and “horizontal,” may be used herein to express and clarify the relationship between various structures. It should be understood that such terms do not denote absolute orientation. Reference herein to “one embodiment,” “an embodiment,” or similar phrases means that a particular feature, structure, or operation described in connection with such phrases can be included in at least one embodiment of the present technology. Thus, such phrases as used herein are not all referring to the same embodiment. Unless preceded with the word “conventional,” reference herein to “counterpart” devices, systems, methods, features, structures, or operations refers to devices, systems, methods, features, structures, or operations in accordance with at least some embodiments of the present technology that are similar to a described device, system, method, feature, structure, or operation in certain respects and different in other respects. Finally, it should be noted that various particular features, structures, and operations of the embodiments described herein may be combined in any suitable manner in additional embodiments in accordance with the present technology.

1. A method of operating a mobile robot, wherein:
during the method:
the mobile robot includes a body and a leg extending distally from the body, the leg defines a kinematic chain and includes:
a first joint rotatable about a first axis,
a second joint distal to the first joint along the kinematic chain and rotatable about a second axis,
a first elongate link between the first and second joints along the kinematic chain, and
a second elongate link distal to the second joint along the kinematic chain,
the first elongate link defines a length intersecting the first and second axes at the first and second joints, respectively, and
the mobile robot defines:
a center of pressure,
a center of gravity,
a first plane that is vertical and parallel to the length of the first elongate link, and
a second plane that intersects the center of pressure, intersects the center of gravity, and is perpendicular to the first plane; and
the method comprises:
operating the mobile robot in a standing state while the length of the first elongate link is less than 45 degrees off vertical, and
operating the mobile robot in a non-standing state while the length of the first elongate link is less than 30 degrees off horizontal and while the second plane intersects a middle 25% of the length of the first elongate link.

2. The method of claim 1, wherein operating the mobile robot in the non-standing state includes operating the mobile robot in a non-standing state while the second plane intersects a middle 15% of the length of the first elongate link.

3. The method of claim 1, wherein operating the mobile robot in the non-standing state includes ambulating the mobile robot in the non-standing state.

4. The method of claim 1, wherein:
during the method:
the leg and the kinematic chain are a first leg and a first kinematic chain, respectively,
the mobile robot includes a second leg extending distally from the body,
the second leg defines a second kinematic chain and includes:
a third joint rotatable about a third axis,
a fourth joint distal to the third joint along the second kinematic chain and rotatable about a fourth axis,
a third elongate link between the third and fourth joints along the second kinematic chain, and
a fourth elongate link distal to the third joint along the second kinematic chain,
the third elongate link defines a length intersecting the third and fourth axes at the third and fourth joints, respectively, and
the mobile robot defines:
a third plane that is vertical and parallel to the length of the third elongate link, and
a fourth plane that intersects the center of pressure, intersects the center of gravity, and is perpendicular to the third plane;
operating the mobile robot in the standing state includes operating the mobile robot in the standing state while the length of the third elongate link is less than 45 degrees off vertical; and
operating the mobile robot in the non-standing state includes operating the mobile robot in the non-standing state while the length of the third elongate link is less than 30 degrees off horizontal and while the fourth plane intersects a middle 25% of the length of the third elongate link.

5. The method of claim 4, wherein:
during the method:
the first leg includes a first foot at a distal end portion of the first kinematic chain, and
the second leg includes a second foot at a distal end portion of the second kinematic chain; and
operating the mobile robot in the non-standing state includes operating the mobile robot in the non-standing state while the first and second feet are planted on a ground surface.

6. The method of claim 4, wherein operating the mobile robot in the non-standing state includes ambulating the mobile robot bipedally in the non-standing state.

7. The method of claim 6, wherein ambulating the mobile robot bipedally in the non-standing state includes executing at least two complete and consecutive steps via the first leg and executing at least two complete and consecutive steps via the second leg.

8. The method of claim 4, wherein, during the method, the mobile robot is humanoid in form, the first elongate link is a thigh link, and the second and fourth planes are coronal planes.

9. The method of claim 8, wherein operating the mobile robot in the non-standing state includes operating the mobile robot in a crouching state.

10. The method of claim 8, further comprising moving the mobile robot from the standing state to the non-standing state while tilting a superior portion of the body anteriorly at least 15 degrees relative to the legs.

11. (canceled)

12. The method of claim 1, wherein during the method:
the leg includes a foot at a distal end portion of the kinematic chain;
the leg defines a total length from a proximalmost joint of the leg to a distalmost portion of the foot; and
the second joint is at a middle 25% of the total length of the leg.

13. The method of claim 1, wherein operating the mobile robot in the non-standing state includes retrieving an object while the mobile robot is in the non-standing state.

14. (canceled)

15. The method of claim 1, wherein:
during the method, the second elongate link defines a length along the kinematic chain;
operating the mobile robot in the standing state includes operating the mobile robot in the standing state while the length of the second elongate link is less than 45 degrees off vertical; and
operating the mobile robot in the non-standing state includes operating the mobile robot in the non-standing state while the length of the second elongate link is less than 45 degrees off vertical.

16. (canceled)

17. (canceled)

18. The method of claim 17, wherein:
operating the mobile robot in the standing state includes operating the mobile robot in the standing state while the second plane intersects the middle 25% of the length of the first elongate link; and
moving the mobile robot from the standing state to the non-standing state includes moving the mobile robot from the standing state to the non-standing state while the second plane intersects the middle 25% of the length of the first elongate link.

19. (canceled)

20. The method of claim 17, wherein:
during the method, the mobile robot operates in an environment including a human;
the method further comprises determining, by a computer system operably associated with the mobile robot, hazard information about the human; and
moving the mobile robot from the standing state to the non-standing state includes moving the mobile robot from the standing state to the non-standing state at least partially in response to the hazard information.

21. The method of claim 20, wherein:
the hazard information is first hazard information the human at a first time before moving the mobile robot from the standing state to the non-standing state;
the method further comprises determining, by the computer system, second hazard information about the human at a second time while the mobile robot is in the non-standing state; and
the method further comprises moving the mobile robot from the non-standing state to the standing state after operating the mobile robot in the non-standing state and at least partially in response to the second hazard information.

22. The method of claim 21, wherein:
determining the first hazard information includes determining a proximity of the human to the mobile robot at the first time; and
determining the second hazard information includes determining a proximity of the human to the mobile robot at the second time.

23. The method of claim 20, wherein determining the hazard information includes:
gathering, via the computer system, sensor data on the environment;
providing, via the computer system, the sensor data to a machine-learning model; and
receiving, via the computer system, the hazard information as an output from the machine-learning model.

24. The method of claim 1, wherein operating the mobile robot in the standing state and operating the mobile robot in the non-standing state occur while the mobile robot is dynamically stable.

25. The method of claim 1, further comprising:
determining a payload mass carried by the mobile robot; and
adjusting a pose of the mobile robot based on the determined payload mass to maintain the second plane intersecting the middle 25% of the length of the first elongate link.

26-51. (canceled)
